(19) United States
(12) Patent Application Publication
(10) Pub. No.: US 2011/0080657 A1
(43) Pub. Date: Apr. 7, 2011

(54) OPTICAL MODULE

(75) Inventors: Toshiaki Takai, Yokohama (JP); Eiji Sakamoto, Yokohama (JP); Shohei Hata, Yokohama (JP)

(73) Assignee: HITACHI CABLE, LTD.

(21) Appl. No.: 12/871,877

(22) Filed: Aug. 30, 2010

(30) Foreign Application Priority Data
Oct. 5, 2009 (JP) 2009-231385

(51) Int. Cl. G02B 3/08

(52) U.S. Cl. 359/742

(57) ABSTRACT

There is provided means of achieving the improvement of optical coupling efficiency between a surface receiving/emitting element and an optical transmission path with a simple structure and low cost. An optical element and a substrate having an optical waveguide layer and electric wiring are connected with each other through a lens having a Fresnel lens shape. A through via is provided in the lens, and the optical element and the electric wiring in the substrate are electrically connected with each other through the through via. Instead of the lens, a unit in which a lens is mounted inside an optical-element mounting substrate may be used.

### CROSS-REFERENCE TO RELATED APPLICATION

The present application claims priority from Japanese Patent Application No. 2009-231385 filed on Oct. 5, 2009, the content of which is hereby incorporated by reference into this application.

### TECHNICAL FIELD OF THE INVENTION

The present invention relates to an optical wiring device of transmitting signals in a substrate, between substrates, between devices, and others with using an optical transmission path, and relates to a method of manufacturing the optical wiring unit.

### BACKGROUND OF THE INVENTION

In a high-speed transmission wire in recent years, a trend of using a device with optical wiring in place of electric wiring has extended from reasons such as 1) wide band, 2) excellent electromagnetic noise immunity, and 3) light and small volume wiring. In the optical wiring device, as one of the most important factors, there is an optical coupling structure having: an optical element such as a semiconductor laser or a photodiode; and an optical transmission path such as an optical fiber or an optical waveguide.

In order to obtain high optical coupling efficiency, a mounting accuracy of several ten μm in multi-mode transmission or several μm in single-mode transmission is required for alignment between the optical element and the optical transmission path. Also, even after a reliability test such as a thermal cycle test or a test under high temperature and high humidity, position gap or delamination has to be prevented. Meanwhile, in the optical wiring, cost reduction is the main premise from a point of view of the replacement from the electric wiring, and therefore, material cost and assembly man-hour have to be suppressed as low as possible.

As an optical coupling structure achieving such a high optical coupling efficiency, there is an optical-element joint structure capable of increasing the optical coupling efficiency with using light-collective efficiency of a lens.

As an example of the optical-element joint structure, there is a technique disclosed in Japanese Patent Application Laid-Open Publication No. 2008-41770 (Patent Document 1). In the technique, a structure is disclosed, in which a surface receiving/emitting element and an optical transmission path below the substrate are optically coupled with each other through a lens by mounting a surface emitting/receiving element such as a vertical cavity surface emitting laser (VCSEL) or surface-entering (surface-receiving) photodiode on a transparent substrate by flip-chip bonding and arranging the lens below the transparent substrate.

Japanese Patent Application Laid-Open Publication No. 2001-166167 (Patent Document 2) discloses a structure in which, a lens having a core layer and a clad layer is formed, and a surface receiving/emitting element is mounted on a position where the element is optically coupled with the core layer functioning optical transmission through the lens.

### SUMMARY OF THE INVENTION

However, a conventional technique has a problem in high efficiency of the light-collective effect or cost. For example, in the structure in Patent Document 1, when the vertical cavity surface emitting laser is considered as the surface receiving/emitting element, the light emitted from the vertical cavity surface emitting laser is propagated as spreading. The coupling efficiency is improved by collecting the spread light by the lens and entering the light to the optical transmission path, and therefore, the vertical cavity surface emitting laser and the lens are desirable to be close to each other. This is because the spread of the light emitted from the vertical cavity surface emitting laser is smaller as the vertical cavity surface emitting laser and the lens is closer, and therefore, the light-collective effect required for the lens can be small.

However, in the structure in Patent Document 1, the surface receiving/emitting element is mounted on a front surface of the transparent substrate, and the lens is mounted on a rear surface thereof. Therefore, the distance between the surface receiving/emitting laser and the lens is lengthened by a thickness of the transparent substrate. In this manner, in the structure in Patent Document 1, a lens having the high light-collective effect is required.

Generally, the lens having the high light-collective effect is thick. On the other hand, a small scale and flexibility are required for the optical wiring device, and therefore, the increased thickness of the lens is not desired, and a practical upper limit exists in the thickness. Therefore, an upper limit exists even in the light-collective effect, and as a result, there is a possibility that the optical coupling effect is reduced.

Also, in the structure in Patent Document 2, a lens is simultaneously manufactured in a photo process of manufacturing an optical transmitting substrate. Therefore, there is a possibility that low cost of the optical wiring is difficult. Further, there is provided the structure in which the surface receiving/emitting element is mounted on the position where the element can be optically coupled with the core layer functioning optical transmission through the lens, and therefore, it is impossible to form the lens thickness to be a bump height of the surface receiving/emitting element or higher. Therefore, in the structure, the light-collective effect of the lens is difficult to be improved.

The present invention is made in consideration of the above-described disadvantage points, and an aim of the present invention is to provide means of achieving improvement of optical coupling effect between a surface receiving/emitting element and an optical transmission path with a simple structure and low cost.

The above and other preferred aims and novel characteristics of the present invention will be apparent from the description of the present specification and the accompanying drawings.

The typical ones of the inventions disclosed in the present application will be briefly described as follows.

In an optical module according to a typical embodiment of the present invention including: an optical element emitting or receiving light; and a substrate having an optical transmission path, the optical element is jointed to the substrate through a lens, the light emitted from the optical element or the light entered to the optical element is optically coupled with the optical transmission path through the lens, and the optical element is electrically connected through electric wiring formed on a surface of the lens.

In another optical module according to a typical embodiment of the present invention including: an optical element emitting or receiving light; and a substrate having an optical transmission path, the optical element is jointed to the substrate through a lens, the light emitted from the optical element or the light entered to the optical element is optically coupled with the optical transmission path through the lens, and the optical element and the substrate are electrically connected with each other through a through via formed on a surface of the lens.

In these optical modules, the lens may be a Fresnel lens.

In still another optical module according to the typical embodiment of the present invention including: an optical element emitting or receiving light; an optical-element mounting substrate on which the optical element is mounted; and a substrate having an optical transmission path, the optical element is jointed to the substrate through the optical-element mounting substrate, the optical-element mounting substrate has a hole in a portion corresponding to an optical path for the light emitted from the optical element or the light entered to the optical element, a resin lens made of a resin which is transparent at a communication wavelength is formed in the hole, the light emitted from the optical element or the light entered to the optical element is optically coupled with the optical transmission path through the resin lens, and the optical element is electrically connected through electric wiring formed on a surface of the optical-element mounting substrate.

In the optical module, the resin lens has a Fresnel lens shape.

In still another optical module according to the typical embodiment of the present invention including: an optical element emitting or receiving light; and a substrate having an optical transmission path optically coupled with the optical element, a resin lens made of a resin which is transparent at a communication wavelength is formed in a portion corresponding to an optical path for the light emitted from the optical element on the substrate or the light entered to the optical element, and the light emitted from the optical element or the light entered to the optical element is optically coupled with the optical transmission path through the resin lens.

In the optical module, the resin lens has a Fresnel lens shape.

In still another optical module according to the typical embodiment of the present invention including: an optical element emitting or receiving light; and a substrate having an optical transmission path, a portion on the substrate corresponding to an optical path for the light emitted from the optical element or the light entered to the optical element has a Fresnel lens shape, and the light emitted from the optical element or the light entered to the optical element is optically coupled with the optical transmission path through a resin lens.

The effects obtained by typical aspects of the present invention will be briefly described below.

By the optical module according to the typical embodiment of the present invention, the optical wiring device of achieving the high optical coupling efficiency can be provided with low cost and a simple process.

### BRIEF DESCRIPTIONS OF THE DRAWINGS

FIG. 1 is a view of a joint structure between an optical element and a substrate, according to a first embodiment of the present invention;

FIG. 2A is a view describing a joint process according to the first embodiment of the present invention;

FIG. 2B is a view describing a joint process according to the first embodiment of the present invention;

FIG. 2C is a view describing a joint process according to the first embodiment of the present invention;

FIG. 3A is a view of another joint structure between the optical element and the substrate, according to the first embodiment of the present invention;

FIG. 3B is a view of another joint structure between the optical element and the substrate, according to the first embodiment of the present invention;

FIG. 3C is a view of another joint structure between the optical element and the substrate, according to the first embodiment of the present invention;

FIG. 3D is a view of another joint structure between the optical element and the substrate, according to the first embodiment of the present invention;

FIG. 4 is a cross-sectional view illustrating the another joint structure between an optical element and a substrate, according to another mode of the first embodiment of the present invention;

FIG. 5A is a view describing a joint process between the optical element and the substrate, according to the mode in FIG. 4;

FIG. 5B is a view describing a joint process between the optical element and the substrate, according to the mode in FIG. 4;

FIG. 5C is a view describing a joint process between the optical element and the substrate, according to the mode in FIG. 4;

FIG. 5D is a view describing a joint process between the optical element and the substrate, according to the mode in FIG. 4;

FIG. 6A is a view describing a structure example of the joint structure between the optical element and the substrate, according to the mode in FIG. 4;

FIG. 6B is a view describing a structure example of the joint structure between the optical element and the substrate, according to the mode in FIG. 4;

FIG. 7 is a cross-sectional view illustrating a joint structure between an optical element and a substrate, according to a second embodiment of the present invention;

FIG. 8A is a view describing a joint process between the optical element and the substrate, according to the second embodiment of the present invention;

FIG. 8B is a view describing a joint process between the optical element and the substrate, according to the second embodiment of the present invention;

FIG. 8C is a view describing a joint process between the optical element and the substrate, according to the second embodiment of the present invention;

FIG. 8D is a view describing a joint process between the optical element and the substrate, according to the second embodiment of the present invention;

FIG. 9 is a view describing a structure example of the joint structure between the optical element and the substrate, according to the second embodiment of the present invention; and

FIG. 10 is a schematic view for describing an optical wiring device using an optical-element joint structure according to a third embodiment of the present invention.

### DESCRIPTIONS OF THE PREFERRED EMBODIMENTS

Hereinafter, a first embodiment of the present invention will be described with reference to drawings.

### First Embodiment

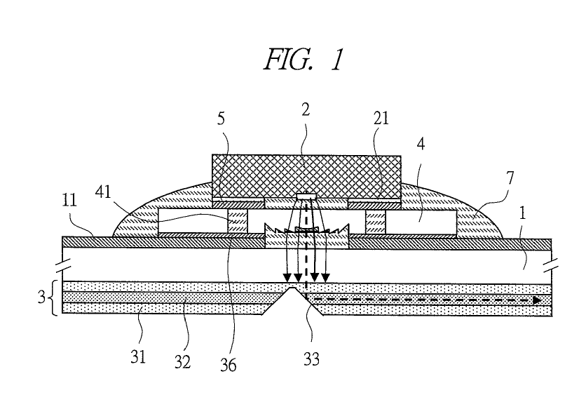

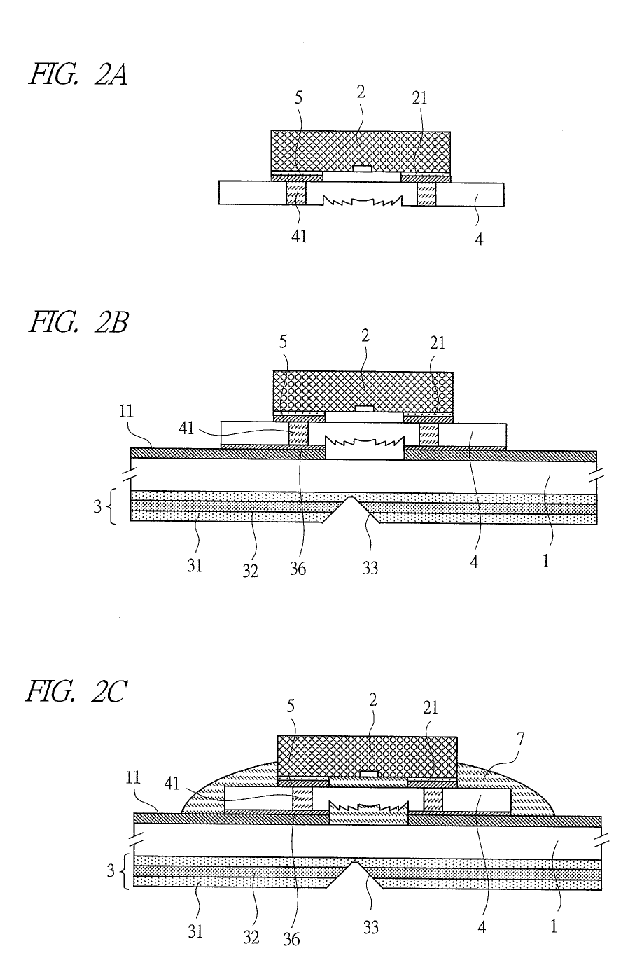

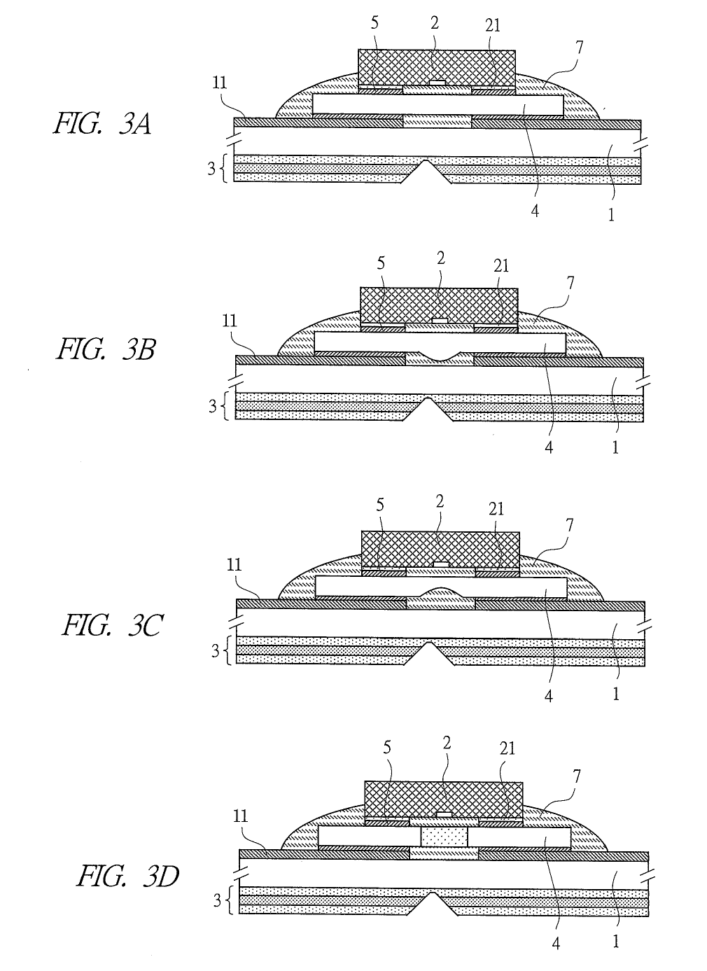

FIG. 1 is a view of a joint structure between an optical element and a substrate, according to a first embodiment of the present invention. FIGS. 2A to 2C are views describing a joint process according to the first embodiment of the present invention. FIGS. 3A to 3D are views of another joint structure between the optical element and the substrate, according to the first embodiment of the present invention.

Note that, in FIGS. 1 to 3, it is needless to say that an upper surface of the substrate and a lower surface thereof are not the same cross-sectional view but a developed cross-sectional view. This also goes for embodiments below.

First, the joint structure of the optical element according to the first embodiment is described with reference to FIG. 1. In FIG. 1, electric wiring 11 is formed on a surface of a substrate 1. In the present embodiment, a flexible substrate made of a polyimide film is used for the substrate 1. Here, a member of the electric wiring 11 has a structure in which milled Cu (copper) having a thickness of 12 μm is mainly used, and Ni (nickel) having a thickness of 2 to 5 μm and Au (gold) having a thickness of 0.05 μm are plated on a surface of the milled Cu.

Other materials can be used for the material of the electric wiring. However, required conditions to the material are desirable to satisfy factors such as a small electric resistance, low cost, and process easiness, which are generally required for the electric wiring.

Note that the Au surface-plating thickness on the surface of the electric wiring 11 depends on a joint method. In the present embodiment, there is provided the structure in which an optical element 2 and the substrate 1 are jointed to each other through a lens 4. At this time, the optical element 2 and the lens 4, and the substrate 1 and the lens 4 are jointed to each other by a joint material 5 formed on the lens 4.

In the present embodiment, as the joint material 5, a deposited solder previously formed on the lens 4 is used. When the joint is performed with the solder, an intermetallic compound is formed at an interface between Au and the solder material after the joint. Since the intermetallic compound is rigid and its stress buffering effect is weak, joint reliability against impact or others is reduced. Also, when Au is residual, it is concerned that the intermetallic compound is further grown by a later process of exposing it under high temperature to cause position gap of the lens 4. Therefore, the Au plating thickness is formed as thin as 0.05 μm.

Further, it is needless to say that the joint material 5 is not limited to be the deposited solder as long as it is a joint material having conductive property such as conductive adhesives or solder paste.

The lens 4 is physically and electrically jointed to the electric wiring 11 on the substrate 1 by the deposited solder 36 (different from the joint material 5, and whether its material is changed or not is a design matter). Note that, in the present embodiment, it is assumed that the deposited solder 36 is previously formed on the lens 4. However, the formation is not limited to this, and the deposited solder 36 may be formed on the electric wiring 11. The joint method between the lens 4 and the substrate 1 is not limited to the deposited-solder jointing, either, and the thickness of the electric wiring 11 may be changed depending on the joint method. For example, when ultrasonic jointing is used, it is desirable to form the Au surface-plating thickness as 0.3 μM.

In the present embodiment, a Fresnel lens is used as the lens 4. This is because, by using the Fresnel lens, the lens can be thinned compared to a normal convex lens when the same light-collective effect is obtained. Therefore, by the thinned lens, the distance between the optical element 2 and the optical waveguide core 31 can be shortened. In this manner, the optical coupling effect is improved.

It is assumed that the lens 4 in FIG. 1 is a uniformed lens module made of a resin or others. The lens 4 has: a refraction unit of optically refracting light; and a physical connection unit except for the refraction unit.

In the lens 4, a through via 41 made of Cu is provided for electrically connecting the substrate 1 with the optical element 2. The through via 41 is provided in the physical connection unit of the lens 4, and electrically connects, by the electric wiring, electrode pads (not illustrated) with each other, which are provided on a surface facing the optical element 2 of the lens 4 and a surface facing the substrate without optical influence. Electric signals from the electric wiring 11 on the substrate 1 are transmitted to the optical element 2 through the through via 41. In a case that the optical element 2 is a light-emitting element, the optical element 2 emits light corresponding to the electric signals transmitted to the optical element 2, so that electric vibration is converted to optical signals.

A case that the optical element 2 is a light-receiving element is considered. Optical signals received on the optical element 2 are converted to electric signals corresponding to the optical signals by the optical element 2. The converted electric signals are transmitted to the electric wiring 11 on the substrate 1 through the through via 41.

Note that a material of the through via 41 is not limited to Cu. It is needless to say that the material of the through via 41 is not limited as long as the material has conductive property.

On a rear surface of the substrate 1, there is provided an optical waveguide layer 3 formed of the optical waveguide core 31 and an optical waveguide clad 32 made of a resin. In an optical path portion (right-below portion of a light-emitting point of the optical element 2 or a light-receiving point thereof) in the optical waveguide layer 3, a 45-degree-angle mirror 33 is formed by half dicing to the optical waveguide layer 3.

A case that the optical element 2 is a light-emitting element is considered. The light propagating from right in the figure to left therein inside the optical waveguide core 31 is reflected upward in the figure by the 45-degree-angle mirror 33. The reflected light is collected to the optical element 2 by the lens 4.

Hereinafter, in the present embodiment, a joint process for the joint structure is described with reference to FIGs. 2A to 2C with exemplifying a vertical cavity surface emitting laser (VCSEL) as the optical element 2.

First, in FIG. 2A, in positions of the optical element 2 and the lens 4, positions of the light-emitting point of the optical element 2 and a center of the lens 4 in a horizontal direction are aligned with each other. The optical element 2 is jointed onto the lens 4 by flip chip bonding. Note that, in the present embodiment, the optical element 2 is jointed onto a pieced lens 4. However, the joint may be provided in a procedure such that, a plurality of optical elements 2 are similarly jointed onto an arrayed lens 4, and then, the arrayed lens 4 is pieced by dicing.

Next, in FIG. 2B, in positions of the substrate 1 and the lens 4, positions of the center of the lens 4 and an edge portion of the optical waveguide core 31 in a horizontal direction are aligned with each other. After the position alignment, the lens 4 and the substrate 1 are jointed to each other by flip chip bonding. By such a position relationship among the optical element 2, the lens 4, and the optical waveguide core 31, the light emitted from the optical element 2 is collected by the lens 4 and is entered into the optical waveguide core 31. In the present embodiment, InP-based VCSEL (thermal expansion coefficient of 4.5 ppm/K) is used as the optical element 2. Also, as the polyimide film for the substrate 1, kapton (thermal expansion coefficient of 20 ppm/K) is used. In order to relax stress caused by a difference between both thermal expansion coefficients, the lens 4 is desirable to be made of a material having a thermal expansion coefficient in a range of 4.5 to 20 ppm/K. At this time, the deposited solder 36 may be formed.

Next, in FIG. 2C, an underfill resin 7 is filled inside spaces between the optical element 2 and the lens 4 and between the lens 4 and the substrate 1, and then, the underfill resin is thermally cured. By filling the underfill resin 7, joint strengths between the optical element 2 and the lens 4 and between the lens 4 and the substrate 1 can be increased, and the stress caused by the external impact can be relaxed. Similarly to the lens 4, the thermal expansion coefficient of the underfill resin 7 is desirable to be between the thermal expansion coefficients of the substrate 1 and the optical element 2 in order to relax the stress caused by the difference between thermal expansion coefficients of the optical element 2 and the substrate 1. Also, when refractive index of the underfill resin 7 is taken as “nₐ” and refractive index of the lens 4 is taken as “n_{b}”, it is desirable to use an underfill resin satisfying a relation of “nₐ<n_{b}”.

Note that the material of the substrate 1 is not limited to polyimide as long as the material is transparent at the communication wavelength. Even a rigid substrate is no problem as the substrate.

Also, in the present embodiment, the solder jointing is used as the joint method for the optical element 2. In this case, it is desirable to use, as the joint material 5, a solder having a lower melting point than an upper temperature limit of the material forming the optical waveguide layer 3 such as Sn-1Ag-57Bi or In-3.5Ag. Also, a joint-material conductive adhesive can be also used as the joint material 5. Even in this case, its thermal curing temperature is similarly desirable to be lower than the upper temperature limit of the material forming the optical waveguide layer 3.

Further, the configuration of the lens 4 according to the present embodiment is not limited to the Fresnel lens. As illustrated in FIGS. 3A to 3D, various methods exist. FIG. 3A illustrates an example using a graded index (GRIN) lens as the lens 4. Also, FIG. 3B illustrates an example using a convex lens as the lens 4. FIG. 3C illustrates an example using a concave lens as the lens 4. FIG. 3D illustrates an example using a diffraction lens as the lens 4.

In this manner, for the configuration of the lens 4, various achieving means exist. If the means can obtain effects of the present invention, they are included within a range of the present invention.

Next, another mode of the present embodiment is described.

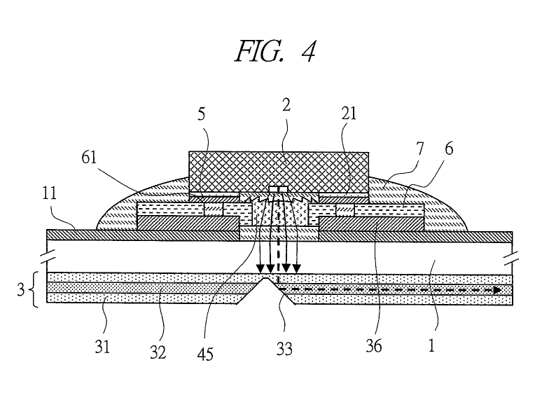

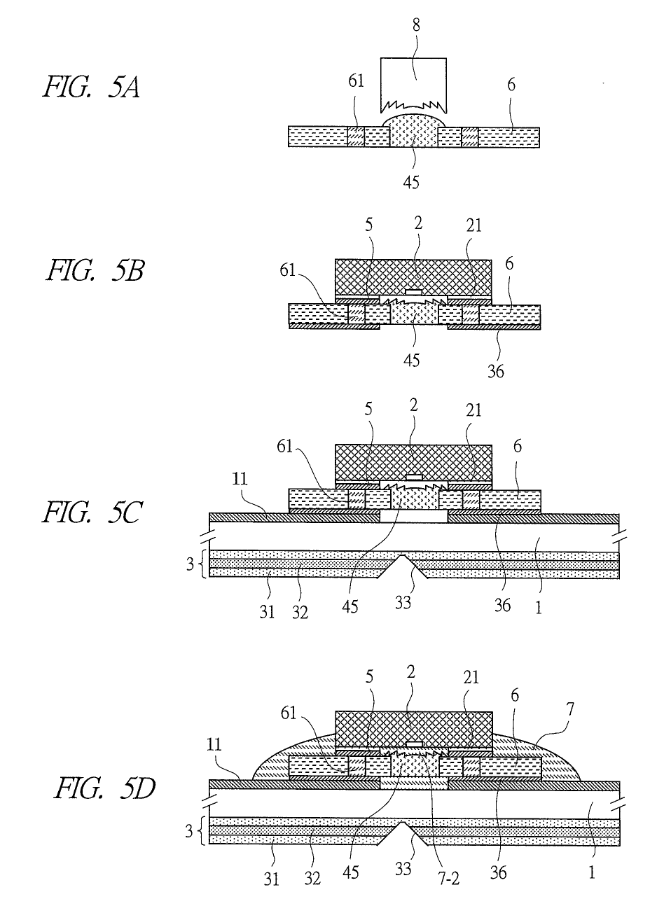

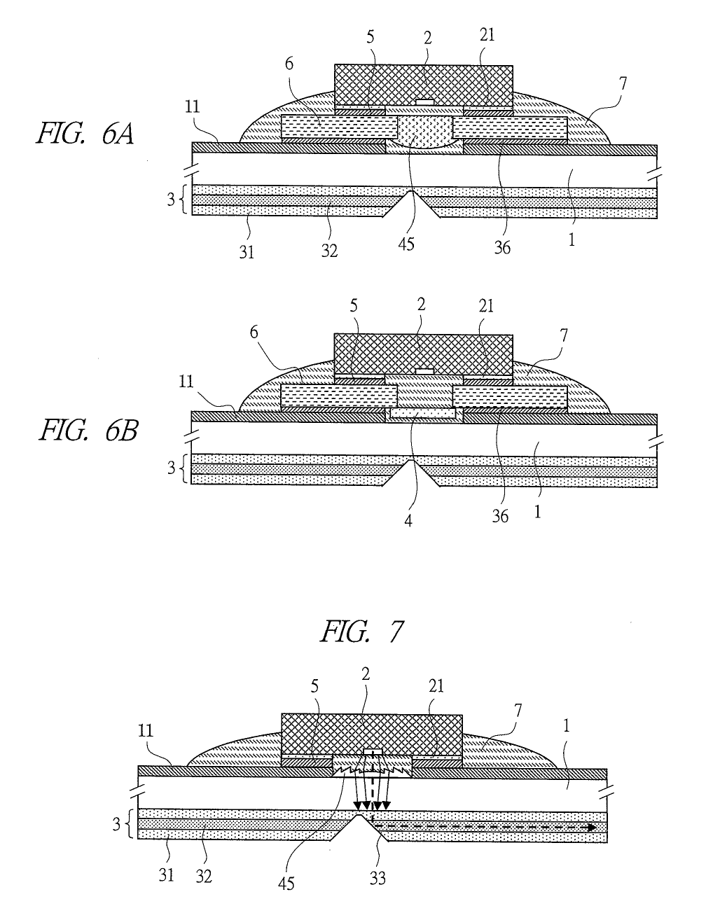

FIG. 4 is a cross-sectional view illustrating a joint structure between the optical element and the substrate, according to another mode of the first embodiment of the present invention. FIGS. 5A to 5D are views describing a joint process between the optical element and the substrate, according to the mode. FIGS. 6A and 6B are views describing a structure example of the joint structure between the optical element and the substrate, according to the mode.

First, the joint structure of the optical element according to the mode is described with reference to FIG. 4.

In the present mode, a point that the optical element 2 is mounted on the substrate 1 through an optical-element mounting substrate 6 is different from FIG. 1.

On front and rear surfaces of the optical-element mounting substrate 6, the deposited solder 36 is previously formed at portions where the optical-element mounting substrate 6 and the optical element 2 are jointed to each other and the optical-element mounting substrate 6 and the substrate 1 are jointed to each other. By the deposited solder 36, the optical-element mounting substrate 6 and the substrate 1 are physically jointed to each other.

In the optical-element mounting substrate 6, there is provided an opening portion at a position corresponding to the optical path for the light emitted from the optical element 2. In the opening portion, a resin having the Fresnel lens shape is formed as a resin lens 45. By using the resin having the Fresnel lens shape, a thickness of the resin lens 45 can be formed as almost same as that of the optical-element mounting substrate 6. In this manner, the distance between the optical element 2 and the optical waveguide core 31 can be shortened. As a result, the optical coupling effect can be improved.

Also, in the optical-element mounting substrate 6, a through via 61 made of Cu is provided for electrically connecting the substrate 1 with the optical element 2. Electric signals from the electric wiring 11 on the substrate 1 are transmitted to the optical element 2 through the through via 61. The optical element 2 emits light corresponding to the electric signals transmitted to the optical element 2, so that the electric signals are converted to optical signals.

The kapton formed of the polyimide film is also used for the substrate 1 in FIG. 4. Also, similarly to FIG. 1, VCSEL is used as the optical element 2.

On a rear surface of the substrate 1, there is provided the optical waveguide layer 3 formed of the optical waveguide core 31 and the optical waveguide clad 32 made of a resin. In an optical path portion in the optical waveguide layer 3, the 45-degree-angle mirror 33 is formed. The light beam emitted from the optical element 2 is collected by the resin lens 45, and is enterrf into the 45-degree-angle mirror 33. The light beam entered into the 45-degree-angle mirror 33 is reflected by the 45-degree-angle mirror 33 and is propagated in the optical waveguide core 31.

Next, the joint process for the present joint structure is described with reference to FIGs. 5A to 5D.

First, a resin is filled inside the opening portion in the optical-element mounting substrate 6, and then, the resin is thermally cured (see in FIG. 5A). The resin is required to be a transparent resin at the communication wavelength. Also, the resin is desirable to be a resin having high transmissivity for the light having the communication wavelength. After the thermal curing to the resin, the resin is pressed by a stamping tool 8 whose tip has the Fresnel lens shape. In this manner, the resin lens 45 having the Fresnel lens shape is formed.

After the process of forming the resin lens 45, in a position relationship between the optical element 2 and the resin lens 45, positions of the light-emitting point of the optical element 2 and a center of the resin lens 45 in a horizontal direction are aligned with each other (see in FIG. 5B). And then, the optical element 2 and the optical-element mounting substrate 6 are jointed to each other by flip chip bonding. Note that, similarly to FIG. 2, the optical element 2 is jointed onto a pieced optical-element mounting substrate 6. However, the joint may be provided in a procedure such that, a plurality of optical elements 2 are similarly jointed onto an arrayed optical-element mounting substrate 6, and then, the arrayed optical-element mounting substrate 6 is pieced by dicing. Also, at this time, the deposited solder 36 may be formed.

And then, in a position relationship between the substrate 1 and the optical-element mounting substrate 6, position alignment is performed so that positions of the center of the resin lens 45 and an edge portion of the optical waveguide core 31 are aligned with each other in a horizontal direction (see in FIG. 5C). After the position alignment, the optical-element mounting substrate 6 and the substrate 1 are jointed to each other by flip chip bonding. By such a position relationship among the optical element 2, the resin lens 45, and the optical waveguide core 31, the light emitted from the optical element 2 is collected by the resin lens 45 and is entered into the optical waveguide core 31. In the present mode, InP-based VCSEL (thermal expansion coefficient of 4.5 ppm/K) is used as the optical element 2, and kapton (thermal expansion coefficient of 20 ppm/K) is used as the polyimide film for the substrate 1. In order to relax stress caused by a difference between both thermal expansion coefficients, the optical-element mounting substrate 6 is desirable to be made of a material having a thermal expansion coefficient in a range of 4.5 to 20 [ppm/K].

After the jointing between the optical-element mounting substrate 6 and the substrate 1, an underfill resin 7-2 is filled between the optical element 2 and the optical-element mounting substrate 6 and between the optical-element mounting substrate 6 and the substrate 1. Also, the underfill resin 7 is put in a periphery of the optical element 2 (see in FIG. 5D).

After the filling, the underfill resin 7 is thermally cured. By filling the underfill resin 7, similarly to the mode in FIG. 1 or others as described above, joint strengths between the optical element 2 and the optical-element mounting substrate 6 and between the optical-element mounting substrate 6 and the substrate 1 can be increased, and the stress caused by the external impact can be relaxed. At this time, similarly to the optical-element mounting substrate 6, in order to relax the stress caused by the difference between thermal expansion coefficients of the optical element 2 and the substrate 1, the thermal expansion coefficient of the underfill resin 7 is desirable to be between the thermal expansion coefficients of the substrate 1 and the optical element 2. Also, when refractive index of the underfill resin 7-2 is taken as “nₐ” and refractive index of the resin lens 45 is taken as “n_{b}”, it is desirable to use an underfill resin satisfying a relation of “nₐ<n_{b}”.

At this time, materials of the underfill resins 7 and 7-2 can be different from each other. At this time, a material focusing on optical characteristics is used for the resin 7-2, and a material focusing on physical characteristics is used for the resin 7.

Even in the mode, similarly to FIG. 3, it is considered that various lenses are applied as types of the resin lens 45. FIG. 6A illustrates an example using a convex lens as the resin lens 45, and FIG. 6B illustrates an example using a diffraction lens as the resin lens 45.

As described above, by providing the lens function on the optical-element mounting substrate 6, high optical coupling effect can be also achieved.

Also, as seen in FIG. 5C, the through via is provided in the optical-element mounting substrate 6, so that the resin lens 45 can be provided upper than a surface of the electric wiring 11 provided on the substrate 1. In this manner, an effect that arrangement flexibility is increased is obtained. In addition, the optical-element mounting substrate 6 is modularized, so that flexibility of improvement due to quantity productivity or lens change can be increased.

### Second Embodiment

Next, a second embodiment of the present invention is described with reference to FIGS. 7 to 9.

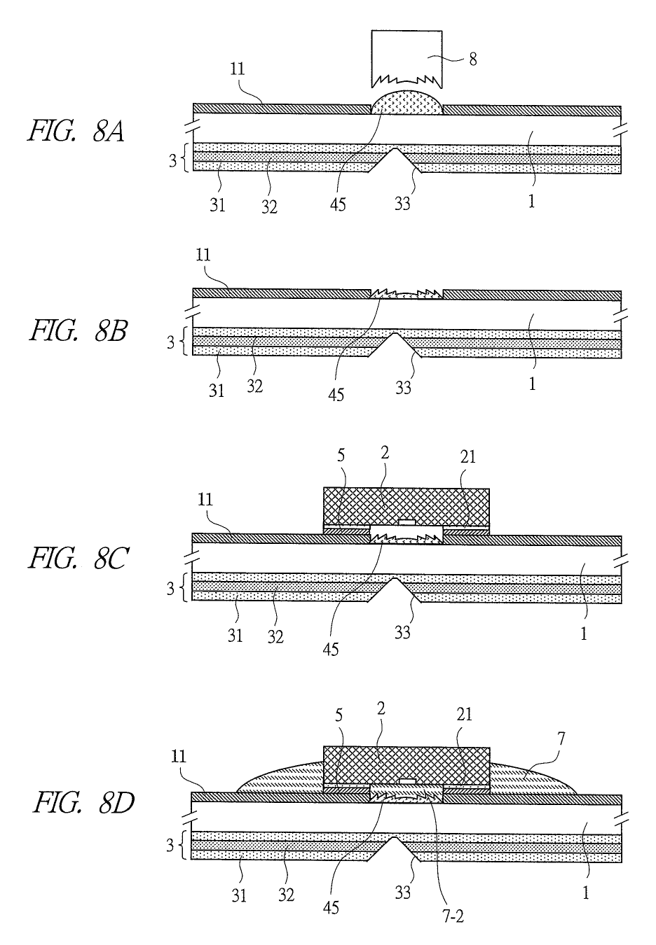

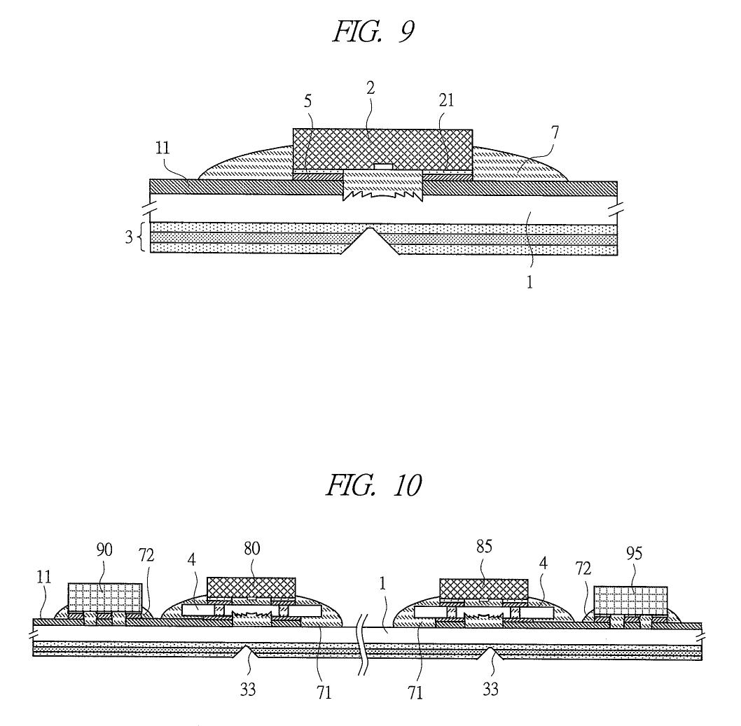

FIG. 7 is a cross-sectional view illustrating a joint structure between an optical element and a substrate, according to a second embodiment of the present invention. FIGS. 8A to 8D are views describing a joint process between the optical element and the substrate, according to the second embodiment of the present invention. FIG. 9 is a view describing a structure example of the joint structure between the optical element and the substrate, according to the second embodiment of the present invention.

Note that, even in the present embodiment, the description is made with using kapton formed of the polyimide film as the substrate 1 and using VCSEL as the optical element 2.

In the present embodiment, the optical element 2 is directly jointed to the substrate 1. And, a resin lens 45 having a Fresnel lens shape is arranged between the substrate 1 and the optical element 2.

On the substrate 1, a resin having the Fresnel lens shape is formed as the resin lens 45 at a corresponding position to an optical path for the light emitted from the optical element 2. Generally, a distance between the substrate 1 and the optical element 2 is very short as several ten μm. Therefore, it is difficult to storage a general lens having a convex lens shape within a space having the distance. Also, even if the lens can be stored, the lens does not have sufficient light-collective effect.

However, if the lens is the resin lens 45 having the Fresnel lens shape, the lens can be stored between the substrate 1 and the optical element 2. Also, by the Fresnel lens shape, the sufficient light-collective effect can be obtained even if the resin lens 45 has a thickness of only several ten μm. As a result, improvement of the optical coupling effect can be achieved.

As described above, in the present embodiment, electric signals from the electric wiring 11 on the substrate 1 are directly transmitted to the optical element 2. The light corresponding to the transmitted electric signals are emitted, so that the optical element 2 converts the electric signals to optical signals.

On a rear surface of the substrate 1, an optical waveguide layer 3 is provided. The optical waveguide layer 3 is formed of an optical waveguide core 31 and an optical waveguide clad 32 made of a resin.

In an optical path portion in the optical waveguide layer 3, a 45-degree-angle mirror 33 is formed. The light beam emitted from the optical element 2 is collected by the resin lens 45, and is entered into the 45-degree-angle mirror 33. The light beam entered into the 45-degree-angle mirror 33 is reflected by the 45-degree-angle mirror 33 and is guided in the optical waveguide core 31.

Next, a joint process for the joint structure according to the present embodiment is described with reference to FIGS. 8A to 8D.

First, in FIGS. 8A and 8B, a resin is potted on a portion on the substrate 1 corresponding to an optical path for the light emitted from the optical element 2, and then, the resin is thermally cured. It is essential that the resin is a transparent resin at a communication wavelength. Also, the resin is desirable to be a resin having high transmissivity to the light having the communication wavelength.

After the thermal curing to the resin, the resin is pressed by a stamping tool 8 whose tip has the Fresnel lens shape. In this manner, the resin has the Fresnel lens shape, so that the resin lens 45 is formed.

Next, in FIG. 8C, in a position relationship between the substrate 1 and the optical element 2, positions of a light-emitting point of the optical element 2 and an edge portion of the optical waveguide core 31 in a horizontal direction are aligned with each other. After the position alignment, the optical element 2 and the substrate 1 are jointed to each other by flip chip bonding.

By such a position relationship among the optical element 2, the resin lens 45, and the optical waveguide core 31, the light emitted from the optical element 2 is collected by the resin lens 45 and is entered into the optical waveguide core 31.

Next, in FIG. 8D, an underfill resin 7-2 is filled inside a space between the optical element 2 and the substrate 1 (see in FIG. 8D), and the underfill resin 7 is put in a periphery of the optical element 2 (see in FIG. 8D). And then, the underfill resins 7 and 7-2 are thermally cured. By filling the underfill resins 7 and 7-2, joint strength between the optical element 2 and the substrate 1 can be increased, and the stress caused by the external impact can be relaxed.

Similarly to the optical-element mounting substrate 6, the thermal expansion coefficient of the underfill resin 7 is desirable to be between the thermal expansion coefficients of the substrate 1 and the optical element 2 in order to relax the stress caused by the difference between thermal expansion coefficients of the optical element 2 and the substrate 1.

Also, when refractive index of the underfill resin 7-2 is taken as “nₐ” and refractive index of the resin lens 45 is taken as “n_{b}”, it is desirable to use an underfill resin satisfying a relation of “nₐ<n_{b}”.

At this time, materials of the underfill resins 7 and 7-2 can be different from each other. At this time, a material focusing on optical characteristics is used for the resin 7-2, and a material focusing on physical characteristics is used for the resin 7.

Note that the configuration of the resin lens 45 according to the present embodiment is not limited to the Fresnel lens in FIG. 7. As illustrated in FIG. 9, the Fresnel lens shape may be provided by shaving (deforming) a position of the substrate 1 corresponding to the optical path for the light emitted from the optical element 2.

### Third Embodiment

Next, an example of an optical wiring device using an optical-element joint structure according to this present embodiment is described with reference to FIG. 10. FIG. 10 is a schematic view for describing an optical wiring device using an optical-element joint structure according to a third embodiment of the present invention.

In this figure, in the electric wiring 11 on an upper surface of the substrate 1, a vertical cavity surface emitting laser (VCSEL) 80, a driver IC 90 for driving the vertical cavity surface emitting laser (VCSEL) 80, a photodiode (PD) 85, and a preamplifier IC 95 for amplifying small signals from the PD 85 with low noises are mounted by flip chip bonding.

Inside portions corresponding to optical paths between the VCSEL 80 and the substrate 1 and between the PD 85 and the substrate 1, a non-filler content underfill resin 71 is filled. Similarly to the driver IC 90 and the preamplifier IC 95, an underfill resin 72 is filled.

On a lower surface of the substrate 1, the optical waveguide layer 3 is provided. In portions right below a light-emitting point of the VCSEL 80 and right below a light-receiving point of the PD 85, a 45-degree-angle mirror 33 made by cutting the optical waveguide layer 3 by 45 degree angles by dicing is formed. In this manner, the driver IC 90 to which electric signals are inputted modulates the laser light of the VCSEL 80 and generates optical signals. The optical signals from the VCSEL 80 are coupled with the optical waveguide core 31 by the 45-degree-angle mirror 33 below the VCSEL 80, and are propagated in the optical waveguide core 31. Further, the propagated optical signals are reflected by the 45-degree-angle mirror 33 corresponding to the PD 85, and are received by the PD 85. The PD 85 converts the received optical signals to electric signals, and the signals are amplified by the preamplifier IC 95.

By providing such an arrangement of each unit and flexibility between the substrate 1 and the optical waveguide layer 3, the invention can be used as signal wiring in a portion where bend performance is required, such as a twofold mobile phone.

In the foregoing, the invention made by the inventors of the present invention has been concretely described based on the embodiments. However, it is needless to say that the present invention is not limited to the foregoing embodiments and various modifications and alterations can be made within the scope of the present invention.

In the present invention, such as a fold mobile phone whose optical communication is performed through a movable unit, a portable information terminal whose communication is performed by multi-mode transmission in near-field communication inside equipment is assumed. However, the invention is not limited to this, and application for a portable information terminal without the movable unit, equipment without portability, or others is included in the invention.

More specifically, the application is considered for an optical-communication module, an optical-record module, a high-speed switching device (router, server, or others), a storage device, an automobile, and others.

What is claimed is:

1. An optical module comprising:
an optical element emitting or receiving light; and
a substrate which has an optical transmission path and electric wiring, wherein
the optical element is jointed to the substrate through a lens,
the optical element is optically coupled with the optical transmission path through the lens, and
the optical element and the electric wiring in the substrate are electrically connected with each other through the lens.

2. The optical module according to claim 1, wherein
the optical element and the substrate are electrically connected with each other through a through via formed in the lens.

3. The optical module according to claim 1, wherein
the lens has an electrode pad on each of a surface facing the optical element and a surface facing the substrate, and
the electrode pad on the optical element side surface is connected with the optical element, and the electrode pad on the substrate side surface is connected with the electric wiring in the substrate.

4. The optical module according to claim 1, wherein
the lens is a Fresnel lens.

5. An optical module comprising:
an optical element emitting or receiving light; and
a first substrate on which the optical element is mounted; and
a second substrate which has an optical transmission path, wherein
the optical element is jointed to the second substrate through the first substrate,
in the first substrate, a hole is provided at a portion corresponding to an optical path for light emitted from the optical element or light entered to the optical element,
a resin lens made of a transparent resin at a communication wavelength is formed in the hole,
the optical element is optically coupled with the optical transmission path through the resin lens, and
the optical element and the electric wiring in the second substrate are electrically connected with each other through a surface of the first substrate.

6. The optical module according to claim 5, wherein
the resin lens has a Fresnel lens shape.

7. An optical module comprising:
an optical element emitting or receiving light; and
a substrate on which the optical element is mounted and which has an optical transmission path optically coupled with the optical element, wherein
a resin lens made of a transparent resin at a communication wavelength is formed at a portion corresponding to an optical path for light emitted from the optical element or light entered to the optical element, and
the optical element is optically coupled with the optical transmission path through the resin lens.

8. The optical module according to claim 7, wherein
the resin lens has a Fresnel lens shape.

9. An optical module comprising:
an optical element emitting or receiving light; and
a substrate which has an optical transmission path, wherein
a portion on the substrate corresponding to an optical path for light emitted from the optical element or light entered to the optical element has a Fresnel lens shape, and
the light emitted from the optical element or the light entered to the optical element is entered to or emitted from the optical transmission path through the portion having the Fresnel lens shape.
